(19) United States
(12) Patent Application Publication
(10) Pub. No.: US 2022/0001563 A1
(43) Pub. Date: Jan. 6, 2022

(54) LCD SCREEN POLARIZER CUTTING DEVICE

(71) Applicant: LITEMAX ELECTRONICS INC., New Taipei City (TW)

(72) Inventor: JUNG-CHI LO, New Taipei City (TW)

(21) Appl. No.: 16/920,756

(22) Filed: Jul. 6, 2020

(51) Int. Cl. B26D 3/06; B26D 7/18; B26D 7/08; G02F 1/13

(52) U.S. Cl. CPC B26D 3/065; B26D 7/1818; G02F 1/133528; G02F 1/1303; B26D 7/088

(57) ABSTRACT

An LCD screen polarizer cutting device includes a cutting unit and a shoveling unit mounted on a control carrier. The cutting unit includes a first and a second cutter arrayed side by side with a space formed between them. The shoveling unit is located behind the cutting unit and includes a first and a second shovel blade. The second shovel blade is located behind the first shovel blade and has a flat end section. Both of the first and the second shovel blade are located corresponding to the space between the first and the second cutter. The cutting unit cuts the LCD screen polarizer and, the shoveling unit shovels up a waste polarizer strip and a glue layer produced after the cutting. By pre-forming a cut groove on the LCD screen polarizer, the LCD screen can be easily cut subsequently to ensure good cutting flatness and upgraded production yield.

### BACKGROUND OF THE INVENTION

### 1. Field of the Invention

The present disclosure relates to a liquid crystal display (LCD) screen polarizer cutting device, and in particular to an LCD screen polarizer cutting device that facilitates subsequent cutting of the LCD screen.

### 2. Description of the Related Art

Generally, in performing cutting of a liquid crystal display (LCD) screen, a cutter such as a diamond blade is pressed against a polarizer on the LCD screen, and then, an external force is applied to the cutter for the same to cut the LCD screen.

In the above described cutting manner, the cutter is brought to directly cut into the LCD screen. In this circumstance, the cutter is very often hindered by or stuck to a glue layer applied between the polarizer and a glass substrate of the LCD screen. As a result, the cutter fails to cut the LCD screen smoothly and the LCD screen production yield is decreased.

### BRIEF SUMMARY OF THE INVENTION

An objective of the present disclosure is to overcome the disadvantages of the prior art by providing an LCD screen polarizer cutting device, with which a cut groove can be pre-formed on the polarizer to facilitate subsequent cutting of the LCD screen, so as to ensure good cut edge flatness and upgraded production yield of the LCD screen.

To achieve at least the above objective, the LCD screen polarizer cutting device according to a preferred embodiment of the present disclosure includes at least one control carrier, a cutting unit and a shoveling unit. The cutting unit is mounted on the control carrier and includes a first cutter and a second cutter. The first and the second cutter are arrayed side by side and have a space formed between them. The shoveling unit is mounted on the control carrier and is located behind the cutting unit. The shoveling unit includes a first shovel blade and a second shovel blade formed at an end thereof. The first shovel blade is located corresponding to the space between the first and the second cutter. The second shovel blade is located behind the first shovel blade and is also located corresponding to the space between the first and the second cutter. And, the second shovel blade has an end that forms a flat end section.

In the LCD screen polarizer cutting device according to the above embodiment, the first shovel blade has an end that includes two laterally adjacent pointed sections and a curved guide surface formed between the two pointed sections.

In the LCD screen polarizer cutting device according to the above embodiment, the first shovel blade and the second shovel blade are two separate members.

In another embodiment of the LCD screen polarizer cutting device, the first shovel blade and the second shovel blade are integrally formed.

In the LCD screen polarizer cutting device according to the above embodiment, there is a pressing roller unit located between the cutting unit and the shoveling unit. The pressing roller unit includes at least one roller, and the roller is located corresponding to the space between the first cutter and the second cutter.

In the LCD screen polarizer cutting device according to the above embodiment, there is a cleaning unit located behind the shoveling unit; and the cleaning unit includes a cleaning head.

With the LCD screen polarizer cutting device of the present disclosure, the cutting unit performs cutting on the LCD screen polarizer in advance, and then the shoveling unit shovels up a waste polarizer strip and a glue layer that appear after the cutting. By pre-forming a cut groove on the LCD screen polarizer with the present disclosure, the LCD screen can be easily cut subsequently to ensure good flatness and upgraded production yield of the LCD screen.

### BRIEF DESCRIPTION OF THE DRAWINGS

FIG. 1 is a side view of an LCD screen polarizer cutting device according to a preferred embodiment of the present disclosure.

FIG. 2 is a fragmentary view of a cutting unit of the LCD screen polarizer cutting device according to the preferred embodiment of the present disclosure.

FIG. 3 is a fragmentary view of a first shovel blade of a shoveling unit of the LCD screen polarizer cutting device according to the preferred embodiment of the present disclosure.

FIG. 4 is a fragmentary view of a second shovel blade of the shoveling unit of the LCD screen polarizer cutting device according to the preferred embodiment of the present disclosure.

FIG. 5 is a fragmentary view of a pressing roller unit of the LCD screen polarizer cutting device according to the preferred embodiment of the present disclosure.

FIG. 6 is a fragmentary view of a cleaning unit of the LCD screen polarizer cutting device according to the preferred embodiment of the present disclosure.

FIG. 7 is a view showing the LCD screen polarizer cutting device according to the preferred embodiment of the present disclosure in use.

FIG. 8 is another view showing the LCD screen polarizer cutting device according to the preferred embodiment of the present disclosure in use.

FIG. 9 shows a shoveling unit of the LCD screen polarizer cutting device according to another embodiment of the present disclosure.

### DETAILED DESCRIPTION OF THE INVENTION

To facilitate understanding of the objects, characteristics and effects of this present disclosure, embodiments together with the attached drawings for the detailed description of the present disclosure are provided. It is noted the present disclosure can be implemented or applied in other embodiments, and many changes and modifications in the described embodiments can be carried out without departing from the spirit of the disclosure, and it is also understood that the preferred embodiments are only illustrative and not intended to limit the present disclosure in any way.

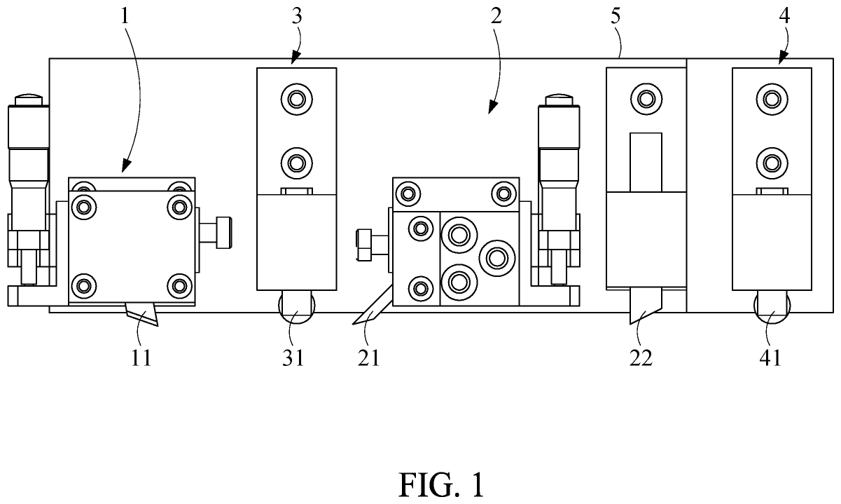

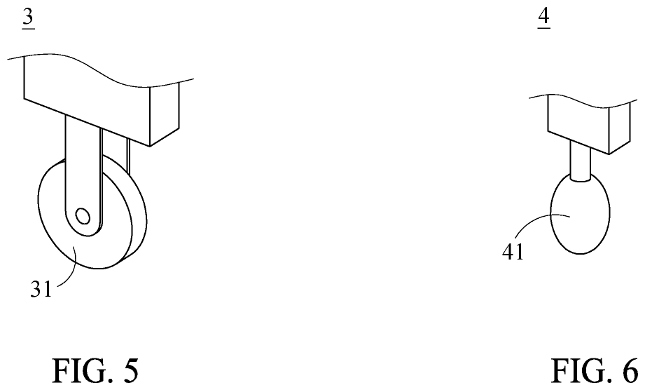

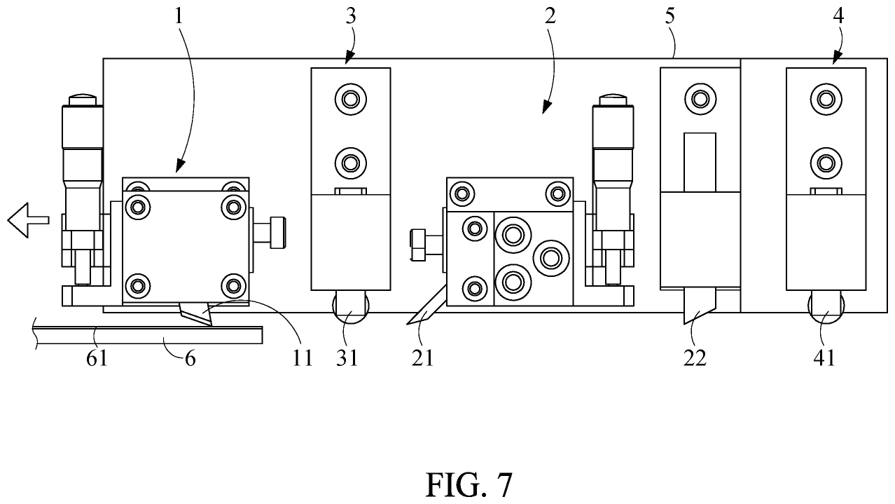

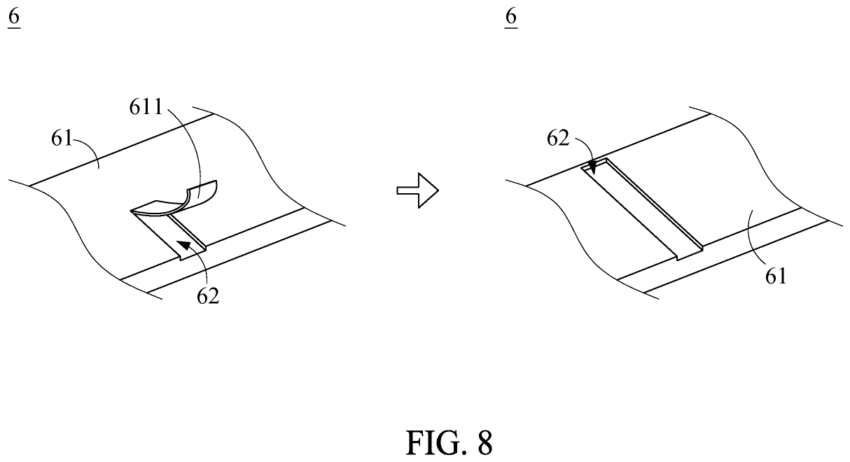

Please refer to FIGS. 1 to 9. The present disclosure provides an LCD screen polarizer cutting device, which includes at least one control carrier 5, a cutting unit 1 and a shoveling unit 2.

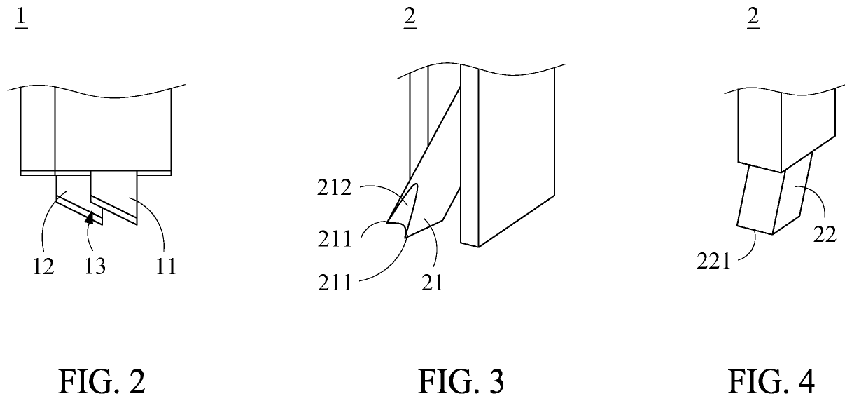

As shown in FIGS. 1 and 2, the cutting unit 1 is mounted on the control carrier 5 and includes a first cutter 11 and a second cutter 12. The first and the second cutter 11, 12 are arrayed side by side and properly separated, so that a space 13 is formed between them.

As shown in FIGS. 1, 3 and 4, the shoveling unit 2 is mounted on the control carrier 5 and located behind the cutting unit 1. The shoveling unit 2 includes a first shovel blade 21 and a second shovel blade 22 formed at an end thereof. The first shovel blade 21 is located corresponding to the space 13 between the first and the second cutter 11, 12. The second shovel blade 22 is located behind the first shovel blade 21 and is also located corresponding to the space 13 between the first and the second cutter 11, 12. An end of the second shovel blade 22 forms a flat end section 221

When setting up the LCD screen polarizer cutting device, the cutting unit 1 and the shoveling unit 2 can be mounted on the same one control carrier 5, as shown in FIG. 1. Alternatively, the cutting unit 1 and the shoveling unit 2 can be separately mounted on two different control carriers (not shown). The cutting unit 1 and the shoveling unit 2 are controlled through the control carrier 5 to operate.

Please refer to FIGS. 1, 4, 7 and 8. When using the LCD screen polarizer cutting device to cut a polarizer 61 of an LCD screen 6, the cutting unit 1 and the shoveling unit 2 are driven by the control carrier 5, such that the first cutter 11 and the second cutter 12 of the cutting unit 1 are pressed against the polarizer 61. Then, the cutting unit 1 and the shoveling unit 2 are moved (or the LCD screen 6 is moved) for the first cutter 11 and the second cutter 12 to perform cutting on the polarizer 61 simultaneously, producing a waste polarizer strip 611 at a location corresponding to the space 13. Following the cutting by the cutting unit 1, the first shovel blade 21 of the shoveling unit 2 shovels and rolls up the waste polarizer strip 611. After the waste polarizer strip 611 is roller up by the first shovel blade 21, a cut groove 62 is formed on the polarizer 61 at the location corresponding to the waste polarizer strip 611. Then, the flat end section 221 of the second shovel blade 22 passes through the cut groove 62 to remove a glue layer (i.e. part of the glue layer applied to between the polarizer 61 and a glass substrate of the LCD screen 6) that exists in the cut groove 62, so as to give the cut groove 62 an improved flatness. The producing of a cut groove 62 on the polarizer 61 of the LCD screen 6 in advance facilitates subsequent cutting work on the LCD screen 6 to enable good cut edge flatness and upgraded production yield of the LCD screen 6.

In an embodiment of the present disclosure as shown in FIGS. 2, 7 and 8, an end of the first shovel blade 21 includes two laterally adjacent pointed sections 211, and a curved guide surface 212 formed between the two pointed sections 211. When using the first shovel blade 21 to shovel up the waste polarizer strip 611, the pointed sections 211 first pick up the waste polarizer strip 611 from two lateral cut edges thereof formed on the polarizer 61 and then shovel up the waste polarizer strip 611. Thereafter, the curved guide surface 212 pushes against the shoveled-up waste polarizer strip 611 to roll up it. In this manner, the waste polarizer strip 611 can be easily shoveled away from the polarizer 61 with the first shovel blade 21.

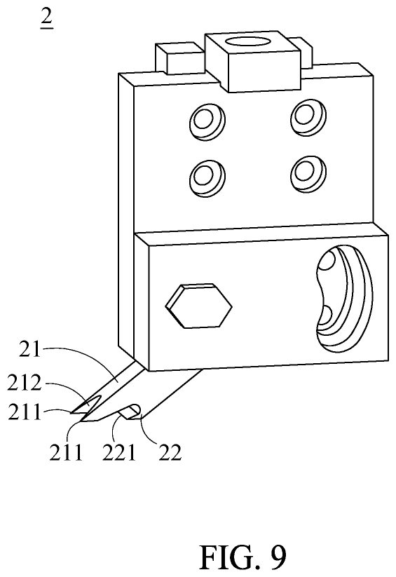

In the illustrated preferred embodiment of the present disclosure, the first shovel blade 21 and the second shovel blade 22 are two separate members, as shown in FIGS. 1, 3 and 4. However, in another embodiment of the present disclosure, the first shovel blade 21 and the second shovel blade 22 can be integrally formed, as shown in FIG. 9. Therefore, different types of the shoveling unit 2 are selectable for use according to actual need in operation to meet different requirements of cutting.

In the preferred embodiment of the present disclosure as shown in FIGS. 1, 5, 7 and 8, a pressing roller unit 3 is further provided between the cutting unit 1 and the shoveling unit 2. The pressing roller unit 3 includes at least one roller 31 located corresponding to the space 13 between the first and the second cutter 11, 12. The cutting unit 1, the shoveling unit 2 and the pressing roller unit 3 can be mounted on the same one control carrier 5, or be separately mounted on different control carriers (not shown). The cutting unit 1, the shoveling unit 2 and the pressing roller unit 3 are controlled through the control carrier 5 to operate.

After the first and the second cutter 11, 12 of the cutting unit 1 perform the cutting on the polarizer 61 simultaneously to produce the waste polarizer strip 611 at the location corresponding to the space 13, the roller 31 of the pressing roller unit 3 is brought to press against the waste polarizer strip 611. Then, the first shovel blade 21 and the second shovel blade 22 of the shoveling unit 2 are brought to shovel and roll up the waste polarizer strip 611. The roller 31 functions to prevent the waste polarizer strip 611 from warping, allowing the shoveling unit 2 to shovel up the waste polarizer strip 611 effectively.

In the preferred embodiment of the present disclosure as shown in FIGS. 1, 6, 7 and 8, a cleaning unit 4 is further included and located behind the shoveling unit 2. The cleaning unit 4 includes a cleaning head 41, which can be a sponge member having cleaning liquid dispensed thereon. The cutting unit 1, the shoveling unit 2, the pressing roller unit 3 and the cleaning unit 4 can be mounted on the same one control carrier 5, or be separately mounted on different control carriers (not shown). The cutting unit 1, the shoveling unit 2, the pressing roller unit 3 and the cleaning unit 4 are controlled through the control carrier 5 to operate.

After the first shovel blade 21 has shoveled and rolled up the waste polarizer strip 611 and the flat end section 221 of the second shovel blade 22 has removed the glue layer on a bottom of the cut groove 62, the cleaning head 41 of the cleaning unit 4 starts cleaning the cut groove 62 to remove chips and residual glue that are produced during the shoveling of the waste polarizer strip 611, so as to allow for subsequent cutting works on the LCD screen 6.

While the present disclosure has been described by means of specific embodiments, numerous modifications and variations could be made thereto by those skilled in the art without departing from the scope and spirit of the present disclosure set forth in the claims.

What is claimed is:

1. An LCD screen polarizer cutting device, comprising:
at least one control carrier;
a cutting unit being mounted on the control carrier and including a first cutter and a second cutter; and the first and the second cutter being arrayed side by side with a space formed between them; and
a shoveling unit being mounted on the control carrier and located behind the cutting unit; the shoveling unit including a first shovel blade and a second shovel blade formed at an end thereof; the first shovel blade being located corresponding to the space between the first and the second cutter; the second shovel blade being located behind the first shovel blade and also being located corresponding to the space between the first and the second cutter; and the second shovel blade having an end that forms a flat end section.

2. The LCD screen polarizer cutting device according to claim 1, wherein the first shovel blade has an end that includes two laterally adjacent pointed sections and a curved guide surface formed between the two pointed sections.

3. The LCD screen polarizer cutting device according to claim 1, wherein the first shovel blade and the second shovel blade are two separate members.

4. The LCD screen polarizer cutting device according to claim 1, wherein the first shovel blade and the second shovel blade are integrally formed.

5. The LCD screen polarizer cutting device according to claim 1, further comprising a pressing roller unit located between the cutting unit and the shoveling unit; the pressing roller unit including at least one roller, and the roller being located corresponding to the space between the first cutter and the second cutter.

6. The LCD screen polarizer cutting device according to claim 1, further comprising a cleaning unit located behind the shoveling unit; and the cleaning unit including a cleaning head.
